(19) United States
(12) Patent Application Publication
(10) Pub. No.: US 2026/0051143 A1
(43) Pub. Date: Feb. 19, 2026

(54) IMAGE PROCESSING DEVICE, IMAGE PROCESSING METHOD, AND COMPUTER-READABLE RECORDING MEDIUM

(71) Applicant: NEC Corporation, Tokyo (JP)

(72) Inventor: Youki SADA, Tokyo (JP)

(73) Assignee: NEC Corporation, Tokyo (JP)

(21) Appl. No.: 19/285,067

(22) Filed: Jul. 30, 2025

(30) Foreign Application Priority Data
Aug. 16, 2024 (JP) 2024-136838

(51) Int. Cl. G06V 10/44

(52) U.S. Cl. CPC G06V 10/44

(57) ABSTRACT

An image processing device includes an extraction unit for extracting a change portion, changed from second output features output at a second time point earlier than a first time point, from among first input features input at the first time point, and generating a change matrix based on the change portion of a first matrix indicating the first input features, and a sparse multi-head self-attention (MSA) processing unit including a linear processing unit that calculates a linear matrix that is a matrix product of the change matrix and a weight matrix, and a substitution unit that substitutes a portion related to the change portion of a second matrix indicating the second output features with the linear matrix calculated by the linear processing unit.

### CROSS REFERENCE TO RELATED APPLICATION

This application is based upon and claims the benefit of priority from Japanese patent application No. 2024-135838, filed on Aug. 16, 2024, the disclosure of which is incorporated herein in its entirety by reference.

### TECHNICAL FIELD

The present disclosure relates to an image processing device, an image processing method, and a computer-readable recording medium that execute image processing at high speed.

### BACKGROUND ART

As a technique for speeding up image processing, a vision transformer (ViT) in which a transformer used in natural language processing is applied to image processing has been known. However, ViT has a complicated structure unlike a conventional convolutional neural network (CNN), and thus computational complexity is extremely high, and is hardly executed at high speed in a high-resolution task.

As a related technique, PTL 1 (JP 2023-042973 A) discloses an image processing device that improves performance of a feature extractor using VIT. The image processing device of PTL 1 (JP 2023-042973 A) first divides an input image into a partial image sequence of a plurality of partial images, and converts the partial images into tokens having fixed dimensional vectors to convert the divided partial image sequence into a token sequence. Next, the image processing device of PTL 1 (JP 2023-042973 A) adds a class-token having a vector of the same dimension as two or more tokens to the tokens, and updates the token sequence to which the class-token is added based on a relevance between the tokens to obtain final encoded representations. Next, the image processing device of PTL 1 (JP 2023-042973 A) acquires encoded representations corresponding to the class-token in the encoded representations as class-token encoded representations, and combines the class-token encoded representations to obtain a feature vector of the input image.

However, the image processing device of PTL 1 (JP 2023-042973 A) does not reduce the computational complexity of ViT by using only a moving token as a calculation target.

### SUMMARY

An object of the present disclosure is to speed up image processing by reducing tokens to be calculated in ViT.

In order to achieve the above object, an image processing device according to one aspect of the present disclosure includes an extraction unit for extracting a change portion, changed from second output features output at a second time point earlier than a first time point, from among first input features input at the first time point, and generating a change matrix based on the change portion of a first matrix indicating the first input features, and a sparse multi-head self-attention (MSA) processing unit including a linear processing unit that calculates a linear matrix that is a matrix product of the change matrix and a weight matrix, and a substitution unit that substitutes a portion related to the change portion of a second matrix indicating the second output features with the linear matrix.

Further, in order to achieve the above object, in an image processing method according to one aspect of the present disclosure, an image processing device extracts a change portion, changed from second output features output at a second time point earlier than a first time point, from among first input features input at the first time point and generates a change matrix based on the change portion of a first matrix indicating the first input features, and executes sparse multi-head self-attention (MSA) processing including calculating a linear matrix that is a matrix product of the change matrix and a weight matrix, and substituting a portion related to the change portion of a second matrix indicating the second output features with the linear matrix.

Furthermore, in order to achieve the above object, a computer-readable recording medium according to one aspect of the present disclosure storing a program for causing a computer to extract a change portion, changed from second output features output at a second time point earlier than a first time point, from among first input features input at the first time point and generate a change matrix based on the change portion of a first matrix indicating the first input features, and execute sparse multi-head self-attention (MSA) processing including calculating a linear matrix that is a matrix product of the change matrix and a weight matrix, and substituting a portion related to the change portion of a second matrix indicating the second output features with the linear matrix.

As described above, according to the present disclosure, the image processing can be speeded up by reducing the tokens to be calculated in ViT.

### BRIEF DESCRIPTION OF THE DRAWINGS

FIG. 1 is a diagram for describing an example of an image processing device;

FIG. 2 is a diagram illustrating an example of a system including the image processing device;

FIGS. 3A and 3B are diagrams for describing MSA processing units using general attention and linear attention;

FIG. 4 is a diagram for describing (1) a token reduction method in MSA in general attention;

FIG. 5 is a diagram for describing an example of a linear processing unit and a substitution unit;

FIG. 6 is a diagram for describing (2) a token reduction method in MSA using SFDA in general attention;

FIG. 7 is a diagram for describing an example of an SFDA processing unit;

FIG. 8 is a diagram for describing (3) a token reduction method in MSA in linear attention;

FIG. 9 is a diagram for describing (4) a token reduction method in MSA using SFDLA in linear attention;

FIG. 10 is a diagram for describing an example of an SFDLA processing unit;

FIG. 11 is a view for describing the operation of the image processing device; and

FIG. 12 is a diagram for describing an example of a computer that achieves an image processing device according to an example embodiment.

### EXAMPLE EMBODIMENT

Hereinafter, an example embodiment will be described with reference to the drawings. In the drawings described below, elements having the same function or matching functions are denoted by the same reference signs, and repeated description thereof may be omitted.

### Example Embodiment

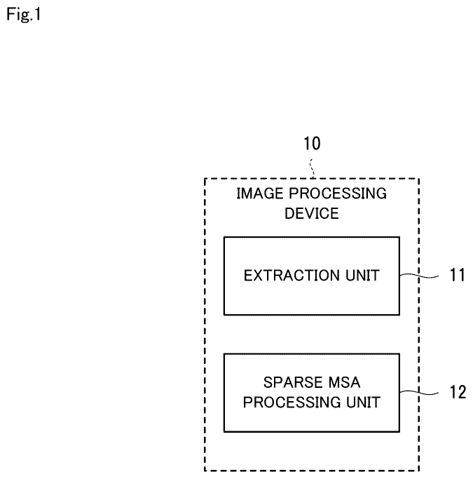

A configuration of an image processing device according to an example embodiment will be described with reference to FIG. 1. FIG. 1 is a diagram for describing an example of an image processing device.

### [Device Configuration]

The image processing device illustrated in FIG. 1 is a device that speeds up image processing by reducing tokens (patches) to be calculated in VIT. The image processing device using ViT is, for example, a device that performs object detection, posture estimation, and the like. Specific examples of the image processing device include a device that performs behavior recognition and analysis in a surveillance camera. As illustrated in FIG. 1, an image processing device 10 includes an extraction unit 11 and a sparse multi-head self-attention (MSA) processing unit 12.

The extraction unit 11 extracts a change portion, changed from second output features output at a second time point earlier than a first time point, from among first input features input at the first time point, and generates a change matrix based on the change portion of a first matrix indicating the first input features.

The sparse MSA processing unit 12 includes a linear processing unit that calculates a linear matrix, which is a matrix product of the change matrix and a weight matrix, and a substitution unit that substitutes a portion related to the change portion of a second matrix indicating the second output features with the linear matrix.

As described above, since the tokens (patches) to be calculated can be reduced by adopting sparse MSA processing in ViT in the example embodiment, the image processing can be speeded up.

### [System Configuration]

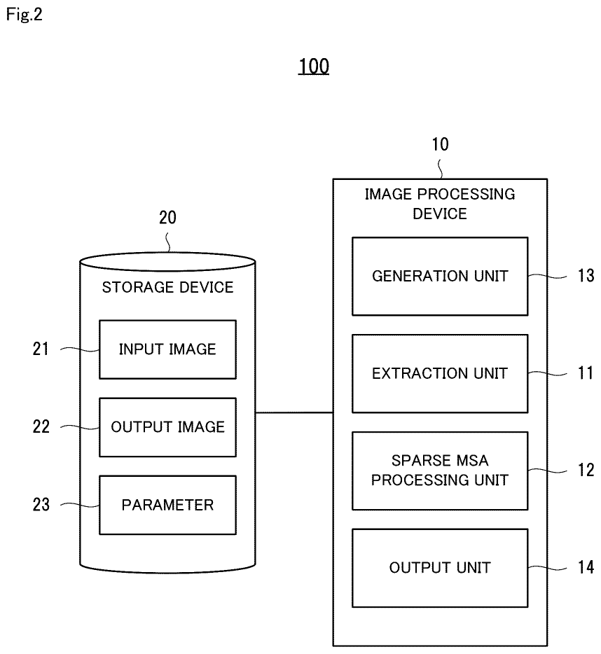

Next, a configuration of the image processing device 10 according to the example embodiment will be described more specifically with reference to FIG. 2. FIG. 2 is a diagram illustrating an example of a system including the image processing device.

As illustrated in FIG. 2, a system 100 in the example embodiment includes the image processing device 10 and a storage device 20.

The image processing device 10 is a device such as a circuit, a server computer, a personal computer, or a mobile terminal equipped with, for example, a central processing unit (CPU), a programmable device such as a field-programmable gate array (FPGA), a graphics processing unit (GPU), or any one or more thereof.

The storage device 20 is a circuit including a database, a server computer, and a memory. The storage device 20 stores, for example, at least information such as an input image 21, an output image 22, and a parameter 23. The storage device 20 is provided outside the image processing device 10 in the example of FIG. 2, but may be provided inside the image processing device 10.

The input image 21 includes a plurality of images captured in time series by an imaging device. The output image 22 includes a plurality of images generated using the sparse MSA processing. The parameter 23 includes various parameters used in the sparse MSA processing.

The image processing device will be described in detail.

The image processing device 10 includes a generation unit 13, the extraction unit 11, the sparse MSA processing unit 12, and an output unit 14.

First, the generation unit 13 acquires images captured in time series by the imaging device (not illustrated). The images may be acquired directly from the imaging device, or the input image 21 may be acquired from the storage device 20.

Next, the generation unit 13 divides each of the acquired images into preset m images. Here, m represents the number of patch dimensions, the number of tokens, the number of patches, or the like.

Next, the generation unit 13 generates a feature vector having preset d features for each of the m divided images (patches) obtained by the division. That is, the generation unit 13 generates a first matrix X(n×m×d) indicating input features. Here, d represents the number of feature dimensions, a channel size, the number of channels, or the like. Further, n represents a patch size. Hereinafter, (n×m×d) indicates that there are n matrices of m rows and d columns.

Refer to Reference [1] for details of the generation unit 13.
[1] Alexey Dosovitskiy, Lucas Beyer, Alexander Kolesnikov, Dirk Weissenborn, Xiaohua Zhai, Thomas Unterthiner, Mostafa Dehghani, Matthias Minderer, Georg Heigold, Sylvain Gelly, Jakob Uszkoreit, Neil Houlsby, “An Image is Worth 16×16 Words: Transformers for Image Recognition at Scale”, [online], Published: 13 Jan. 2021, Last Modified: 17 Sep. 2023, International Conference on Learning Representations ICLR 2021, [Searched on Sep. 27, 2023], Internet <URL: https://openreview.net/forum?id=YicbFdNTTy>

The extraction unit 11 first extracts a change portion, changed from second output features (Yt−1(n×m×d)) output at a second time point t−1 earlier than a first time point t, from among first input features (Xt(n×m×d)) input at the first time point t.

Next, the extraction unit 11 generates a change matrix Xc(m′×d) based on the change portion of the first matrix Xt(n×m×d) indicating the first input features. Here, m′ represents the number of patch dimensions, the number of tokens, the number of patches, or the like of the change portion.

The sparse MSA processing unit 12 calculates a linear matrix L(m′×d), which is a matrix product of the change matrix Xc(m′×d) and a weight matrix W(d×d), and substitutes a portion related to the change portion of a second matrix Yt−1(n×m×d) indicating the second output features with the linear matrix L(m′×d). Note that details of the sparse MSA processing unit 12 will be described later.

The output unit 14 stores first output features (Yt(n×m×d)) generated by the sparse MSA processing unit 12 in the output image 22 of the storage device 20. The output unit 14 may output the output image 22 to an output device (not illustrated).

The output device outputs the output image 22 converted into an outputtable format. The output device is, for example, an image display device using liquid crystal, organic electro luminescence (EL), or a cathode ray tube (CRT). Furthermore, the image display device may include an audio output device such as a speaker.

### The Sparse MSA Processing Will be Described in Detail.

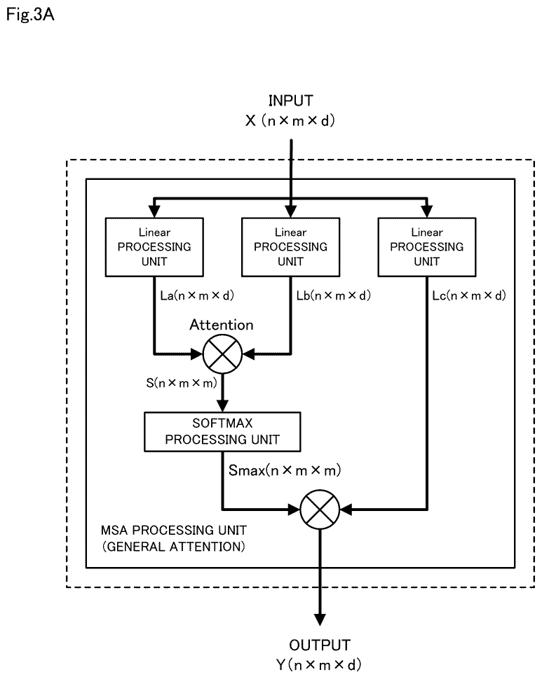

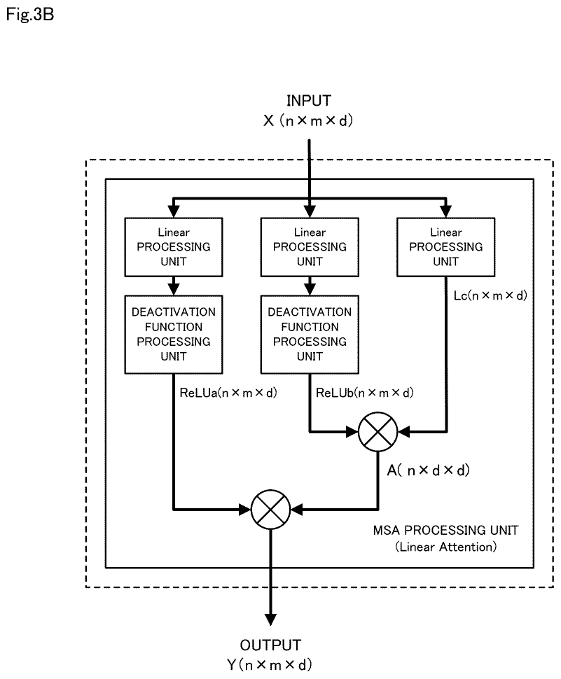

First, conventional MSA processing units will be described. FIGS. 3A and 3B are diagrams for describing MSA processing units using general attention and linear attention. FIG. 3A illustrates the MSA processing unit of general attention, and FIG. 3B illustrates the MSA processing unit of linear attention. In the MSA processing unit of general attention, computational complexity in a matrix product in linear processing units is n·m·d² (hereinafter, “·” indicates multiplication), and computational complexity in a matrix product after attention is n·m²·d. In the MSA processing unit of linear attention, computational complexity is n·m·d² in all matrix products. Note that a deactivation function processing unit is, for example, a processing unit such as rectified linear unit (ReLU) in a neural network.

Next, the sparse MSA processing is processing of reducing the computational complexity in the conventional MSA processing units using general attention and linear attention. For example, sparse MSA processing illustrated in (1), (2), (3), and (4) can be considered. (1) A token reduction method in general attention, (2) a token reduction method using sparse frame difference attention (SFDA) in general attention, (3) a token reduction method in linear attention, and (4) a token reduction method using sparse frame difference linear attention (SFDLA) in linear attention are considered. Specifically, the computational complexity is reduced by reducing tokens to be calculated in the sparse MSA processing illustrated in (1), (2), (3), and (4).

### (1) Token Reduction Method in General Attention

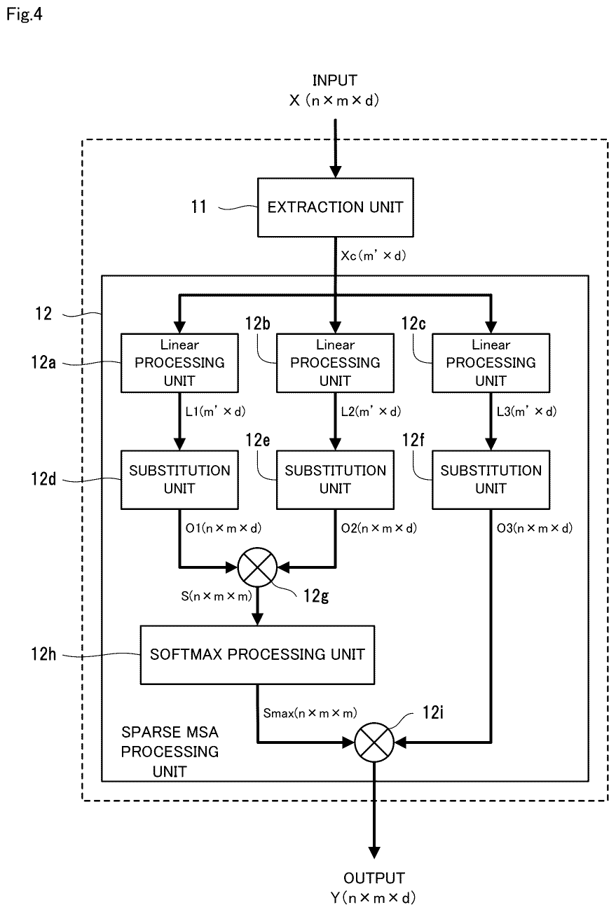

FIG. 4 is a diagram for describing (1) a token reduction method in MSA in general attention. In the example of FIG. 4, the sparse MSA processing unit 12 includes a linear processing unit (first linear processing unit) 12a, a linear processing unit (second linear processing unit) 12b, a linear processing unit (third linear processing unit) 12c, a substitution unit (first substitution unit) 12d, a substitution unit (second substitution unit) 12e, a substitution unit (third substitution unit) 12f, an attention unit (first attention unit) 12g, a softmax processing unit 12h, and an attention unit (second attention unit) 12i.

The linear processing unit 12a calculates a linear matrix L1(m′×d) using the change matrix Xc(m′×d) and a weight matrix W1(d×d) stored in advance in the parameter 23 of the storage device 20, and outputs the linear matrix L1(m′×d) to the substitution unit 12d.

The linear processing unit 12b calculates a linear matrix L2(m′×d) using the change matrix Xc(m′×d) and a weight matrix W2(d×d) stored in advance in the parameter 23 of the storage device 20, and outputs the linear matrix L2(m′×d) to the substitution unit 12e.

The linear processing unit 12c calculates a linear matrix L3(m′×d) using the change matrix Xc(m′×d) and a weight matrix W3(d×d) stored in advance in the parameter 23 of the storage device 20, and outputs the linear matrix L3(m′×d) to the substitution unit 12f.

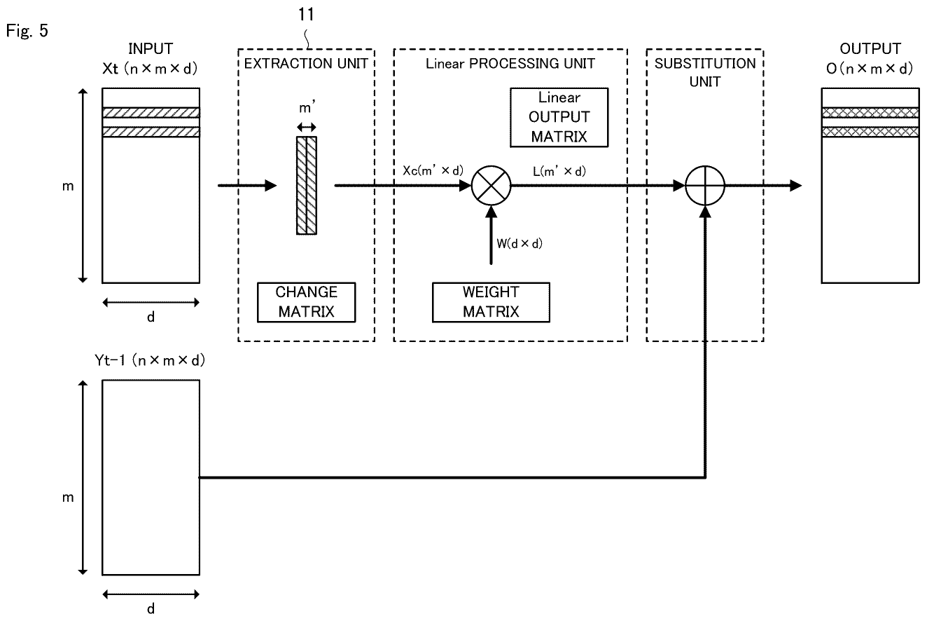

FIG. 5 is a diagram for describing an example of a linear processing unit and a substitution unit. Specifically, as illustrated in FIG. 5, the linear processing unit calculates the matrix product of the change matrix Xc(m′×d) and the weight matrix W(d×d) to calculate the linear matrix L(m′×d).

The substitution unit 12d is provided at a subsequent stage of the linear processing unit 12a. The substitution unit 12d substitutes (updates) a portion related to the change portion of the second matrix Yt−1(n×m×d) indicating the second output features with the linear matrix L1(m′×d) calculated by the linear processing unit 12a to calculate a substitution matrix O1(n×m×d), and outputs the substitution matrix O1(n×m×d) to the attention unit 12g.

The substitution unit 12e is provided at a subsequent stage of the linear processing unit 12b. The substitution unit 12e substitutes (updates) a portion related to the change portion of the second matrix Yt−1(n×m×d) indicating the second output features with the linear matrix L2(m′×d) calculated by the linear processing unit 12b to calculate a substitution matrix O2(n×m×d), and outputs the substitution matrix O2(n×m×d) to the attention unit 12g.

The substitution unit 12f is provided at a subsequent stage of the linear processing unit 12c. The substitution unit 12f substitutes (updates) a portion related to the change portion of the second matrix Yt−1(n×m×d) indicating the second output features with the linear matrix L3(m′×d) calculated by the linear processing unit 12c to calculate a substitution matrix O3(n×m×d), and outputs the substitution matrix O3(n×m×d) to the attention unit 12i.

Specifically, as illustrated in FIG. 5, the substitution unit substitutes portions (hatched portions) related to the change portion of the second matrix Yt−1(n×m×d) with the linear matrix L(m′×d)(grid portions: updated sites) using a matrix sum.

The attention unit 12g calculates a matrix product of the substitution matrix O1(n×m×d) calculated by the substitution unit 12d and the substitution matrix O2(n×m×d) calculated by the substitution unit 12e to generate a matrix S(n×m×m)(third matrix), and outputs the matrix S to the softmax processing unit 12h.

The softmax processing unit 12h normalizes the matrix S(n×m×m) output from the attention unit 12g using the softmax function to calculate a normalized matrix Smax(n×m×m), and outputs the normalized matrix Smax(n×m×m) to the attention unit 12i.

The attention unit 12i calculates a matrix product of the substitution matrix O3(n×m×d) calculated by the substitution unit 12f and the normalized matrix Smax(n×m×m), and outputs a matrix Yt(n×m×d) indicating new second output features.

As described above, when the sparse MSA processing of (1) is adopted, the extraction unit 11 extracts a change portion of tokens, the linear processing units 12a, 12b, and 12c perform linear processing using only compressed change matrices (two-dimensional matrices), related to the change portion, and the substitution units 12d, 12e, and 12f substitute the change portion, so that the computational complexity can be reduced as compared with the conventional MSA processing. As a result, the image processing can be speeded up.

Since a result obtained by calculating the tokens at the previous time is reused except for an important token that has changed, the accuracy slightly deteriorates. Therefore, the accuracy is restored by relearning in many methods, but the present method does not require costly relearning.

### (2) Token Reduction Method Using SFDA in General Attention

In the method of (2), instead of the substitution unit 12d, the substitution unit 12e, and the attention unit 12g in FIGS. 3A and 3B, an SFDA processing unit 12k is provided at a subsequent stage of the linear processing unit 12a and the linear processing unit 12b.

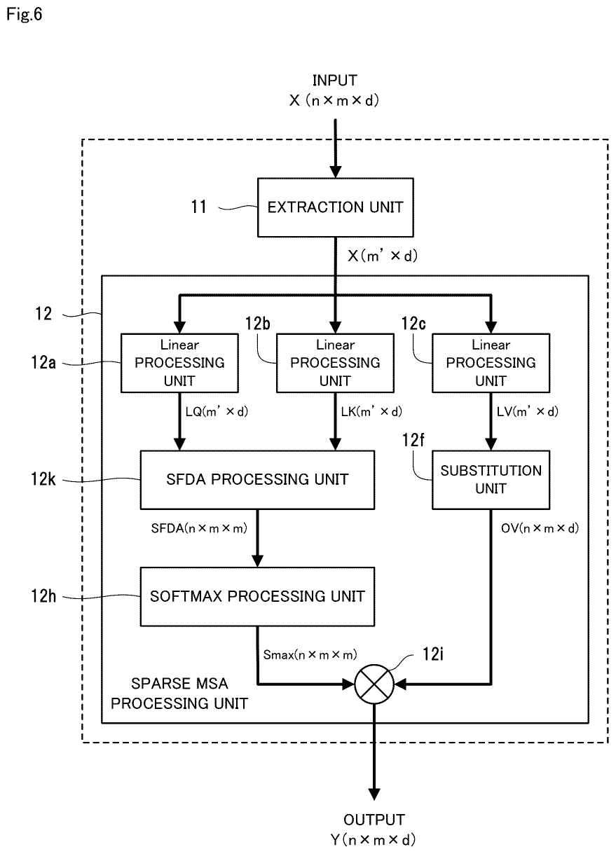

FIG. 6 is a diagram for describing (2) a token reduction method in MSA using SFDA in general attention. In the example of FIG. 6, the sparse MSA processing unit 12 includes the linear processing unit (first linear processing unit) 12a, the linear processing unit (second linear processing unit) 12b, the linear processing unit (third linear processing unit) 12c, the sparse frame difference attention (SFDA) processing unit 12k, the substitution unit (third substitution unit) 12f, the softmax processing unit 12h, and the attention unit (second attention unit) 12i.

The linear processing unit 12a calculates a linear matrix LQ(m′×d)(Q: query) using the change matrix Xc(m′×d) and the weight matrix W1(d×d) stored in advance in the parameter 23 of the storage device 20.

The linear processing unit 12b calculates a linear matrix LK(m′×d)(K: key) using the change matrix Xc(m′×d) and the weight matrix W2(d×d) stored in advance in the parameter 23 of the storage device 20.

The linear processing unit 12c calculates a linear matrix LV(m′×d)(V: value) using the change matrix Xc(m′×d) and the weight matrix W3(d×d) stored in advance in the parameter 23 of the storage device 20.

First, the SFDA processing unit 12k calculates a K change matrix using the linear matrix LQ(m′×d) calculated by the linear processing unit 12a and a K matrix (the first matrix Xt(n×m×d) indicating the first input features). Further, the SFDA processing unit 12k also calculates a Q change matrix using the linear matrix LK(m′×d) calculated by the linear processing unit 12b and a Q matrix (the first matrix Xt(n×m×d) indicating the first input features).

Next, the SFDA processing unit 12k substitutes (updates) the portion related to the change portion of the second matrix Yt−1 (n×m×d) with the K change matrix and the Q change matrix to generate a matrix SFDA(n×m×d)(third matrix), and outputs the matrix SFDA(n×m×d) to the softmax processing unit 12h.

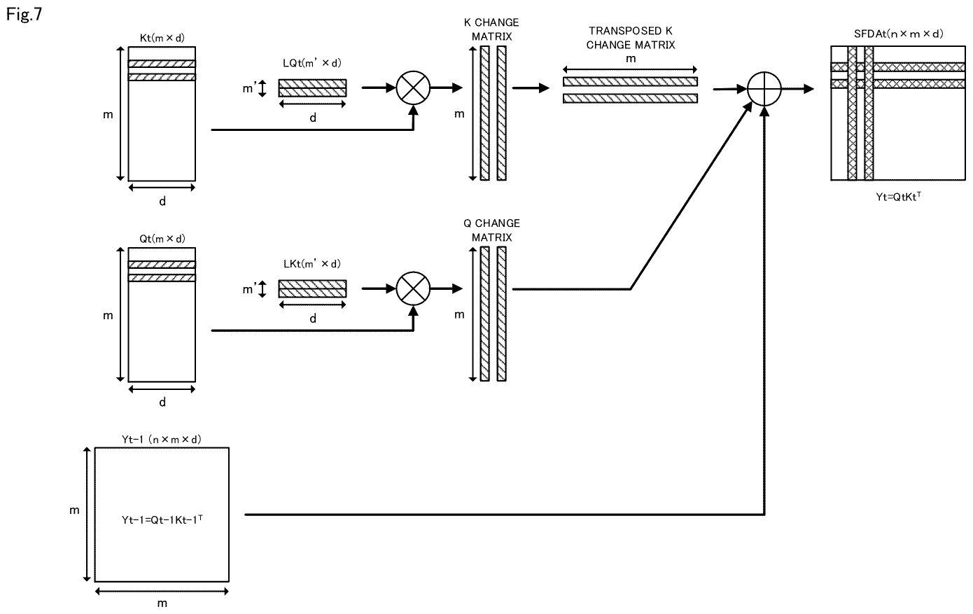

FIG. 7 is a diagram for describing an example of an SFDA processing unit. Specifically, as illustrated in FIG. 7, the SFDA processing unit 12k calculates the K change matrix using a linear matrix LQt(m′×d) and a K matrix Kt(m×d)(the first matrix Xt(n×m×d)) at the first time point t. Further, the Q change matrix is also calculated using a linear matrix LKt(m′×d) and a Q matrix Qt(m×d)(the first matrix Xt(n×m×d)) at the first time point t.

Next, the SFDA processing unit 12k substitutes (updates) a portion related to the change portion of the second matrix Yt−1(n×m×d) at the second time point t−1 using the transposed K change matrix and Q change matrix to generate a matrix SFDAt(n×m×m)(third matrix).

The softmax processing unit 12h normalizes the matrix SFDA(n×m×m) output by the SFDA processing unit 12k using the softmax function to calculate the normalized matrix Smax(n×m×m), and outputs the normalized matrix Smax to the attention unit 12i.

The substitution unit 12f is provided at a subsequent stage of the linear processing unit 12c. The substitution unit 12f substitutes (updates) a portion related to the change portion of the second matrix Yt−1(n×m×d) indicating the second output features with the linear matrix LV(m′×d) calculated by the linear processing unit 12c to calculate a substitution matrix OV(n×m×d), and outputs the substitution matrix OV(n×m×d) to the attention unit 12i.

The attention unit 12i calculates a matrix product of the substitution matrix OV(n×m×d) calculated by the substitution unit 12f and the normalized matrix Smax(n×m×m), and outputs the matrix Yt(n×m×d) indicating new second output features.

As described above, when the sparse MSA processing of (2) is adopted, the extraction unit 11 extracts a change portion of tokens, the linear processing units 12a, 12b, and 12c perform linear processing using only compressed change matrices (two-dimensional matrices), related to the change portion, and the SFDA processing unit 12k and the substitution unit 12f substitute the change portion, so that the computational complexity can be reduced as compared with the conventional MSA processing. As a result, the image processing can be speeded up.

Since a result obtained by calculating the tokens at the previous time is reused except for an important token that has changed, the accuracy slightly deteriorates. Therefore, the accuracy is restored by relearning in many methods, but the present method does not require costly relearning. As compared with the method of (1), it is possible to significantly reduce the computational complexity of attention and to further speed up the image processing.

### (3) Token Reduction Method in Linear Attention

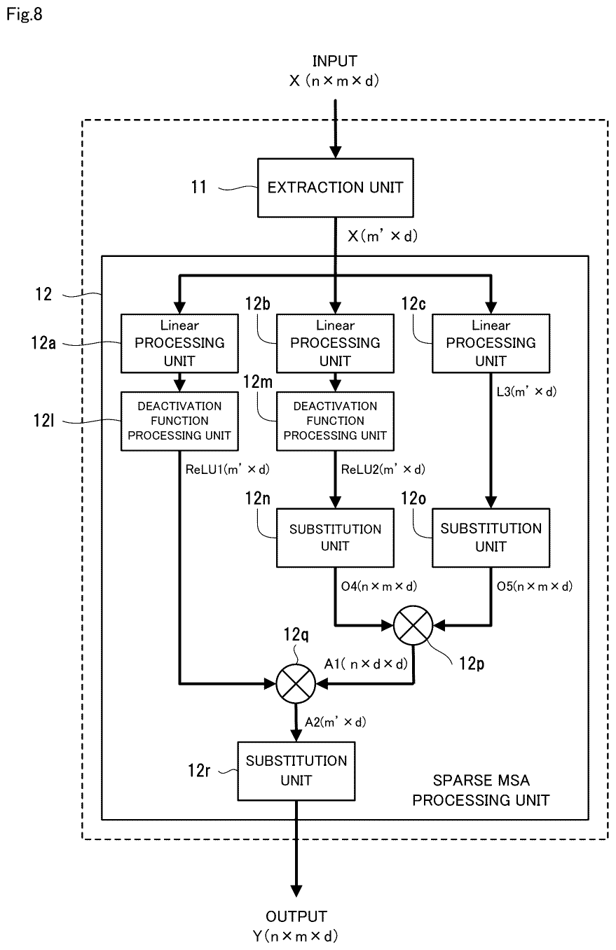

FIG. 8 is a diagram for describing (3) a token reduction method in MSA in linear attention. In the example of FIG. 8, the sparse MSA processing unit 12 includes the linear processing unit (first linear processing unit) 12a, the linear processing unit (second linear processing unit) 12b, the linear processing unit (third linear processing unit) 12c, a deactivation function processing unit 121, a deactivation function processing unit 12m, a substitution unit (fourth substitution unit) 12n, a substitution unit (fifth substitution unit) 120, an attention unit (third attention unit) 12p, an attention unit (fourth attention unit) 12q, and a substitution unit (sixth substitution unit) 12r.

The linear processing unit 12a calculates the linear matrix L1(m′×d) using the change matrix Xc(m′×d) and the weight matrix W1(d×d) stored in advance in the parameter 23 of the storage device 20, and outputs the linear matrix L1(m′×d) to the deactivation function processing unit (first deactivation function processing unit) 121.

The linear processing unit 12b calculates the linear matrix L2 (m′×d) using the change matrix Xc(m′×d) and the weight matrix W2(d×d) stored in advance in the parameter 23 of the storage device 20, and outputs the linear matrix L2 (m′×d) to the deactivation function processing unit (second deactivation function processing unit) 12m.

The linear processing unit 12c calculates a linear matrix L3(m′×d) using the change matrix Xc(m′×d) and a weight matrix W3(d×d) stored in advance in the parameter 23 of the storage device 20, and outputs the linear matrix L3(m′×d) to the substitution unit 120.

The deactivation function processing unit 121 is provided at a subsequent stage of the linear processing unit 12a. The deactivation function processing unit 121 performs deactivation function processing on the linear matrix L1(m′×d) calculated by the linear processing unit 12a to calculate a matrix ReLU1(m′×d), and outputs the matrix ReLU1(m′×d) to the attention unit 12q.

The deactivation function processing unit 12m is provided at a subsequent stage of the linear processing unit 12b. The deactivation function processing unit 12m performs deactivation function processing on the linear matrix L2(m′×d) calculated by the linear processing unit 12b to calculate a matrix ReLU2(m′×d), and outputs the matrix ReLU2(m′×d) to the substitution unit 12n.

The substitution unit 12n is provided at a subsequent stage of the deactivation function processing unit 12m. The substitution unit 12n substitutes (updates) a portion related to the change portion of the second matrix Yt−1(n×m×d) indicating the second output features with the matrix ReLU2(m′×d) calculated by the deactivation function processing unit 12m to calculate a substitution matrix O4(n×m×d), and outputs the substitution matrix O4(n×m×d) to the attention unit 12p.

The substitution unit 120 is provided at a subsequent stage of the linear processing unit 12c. The substitution unit 120 substitutes (updates) a portion related to the change portion of the second matrix Yt−1(n×m×d) indicating the second output features with the linear matrix L3(m′×d) calculated by the linear processing unit 12c to calculate a substitution matrix O5(n×m×d), and outputs the substitution matrix O5(n×m×d) to the attention unit 12p.

The attention unit 12p calculates a matrix product of the substitution matrix O4(n×m×d) calculated by the substitution unit 12n and the substitution matrix O5(n×m×d) calculated by the substitution unit 120, and outputs a matrix A1(n×d×d)(fourth matrix).

The attention unit 12q calculates a matrix product of the matrix ReLU1(m′×d) calculated by the deactivation function processing unit 121 and the matrix A1(n×d×d) calculated by the attention unit 12p, and outputs a matrix A2(m′×d)(fifth matrix) to the substitution unit 12r.

The substitution unit 12r substitutes a portion related to the change portion of the second matrix Yt−1(n×m×d) indicating the second output features with the matrix A2(m′×d) calculated by the attention unit 12q, and outputs the matrix Yt(n×m×d) indicating new second output features.

As described above, when the sparse MSA processing of (3) is adopted, the extraction unit 11 extracts a change portion of tokens, the linear processing units 12a, 12b, and 12c perform linear processing using only compressed change matrices (two-dimensional matrices), related to the change portion, and the substitution units 12n, 12o, and 12r substitute the change portion, so that the computational complexity can be reduced as compared with the conventional MSA processing using linear attention. As a result, the image processing can be speeded up.

### (4) Token Reduction Method Using SFDLA in Linear Attention

In the method of (4), instead of the substitution unit 12n, the substitution unit 120, and the attention unit 12p in FIG. 7, an SFDLA processing unit 12s is provided at a subsequent stage of the deactivation function processing unit 12m and the linear processing unit 12c.

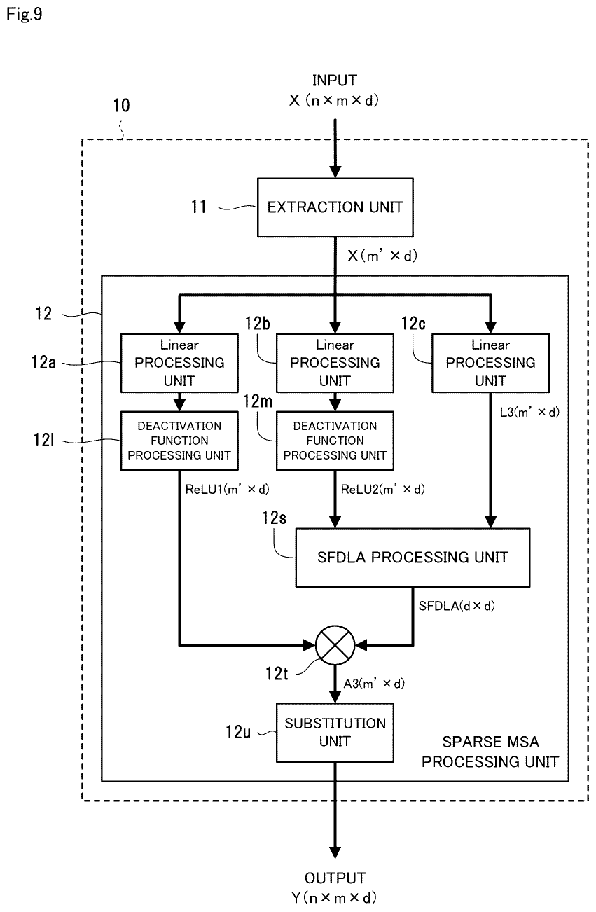

FIG. 9 is a diagram for describing (4) a token reduction method in MSA using SFDLA in linear attention. In the example of FIG. 9, the sparse MSA processing unit 12 includes a linear processing unit (first linear processing unit) 12a, a linear processing unit (second linear processing unit) 12b, a linear processing unit (third linear processing unit) 12c, a deactivation function processing unit 121, a deactivation function processing unit 12m, an SFDLA processing unit 12s, an attention unit (fifth attention unit) 12t, and a substitution unit (seventh substitution unit) 12u.

The linear processing unit 12a calculates the linear matrix L1 (m′×d) using the change matrix Xc(m′×d) and the weight matrix W1(d×d) stored in advance in the parameter 23 of the storage device 20, and outputs the linear matrix L1 (m′×d) to the deactivation function processing unit (first deactivation function processing unit) 121.

The linear processing unit 12b calculates the linear matrix L2 (m′×d) using the change matrix Xc(m′×d) and the weight matrix W2(d×d) stored in advance in the parameter 23 of the storage device 20, and outputs the linear matrix L2 (m′×d) to the deactivation function processing unit (second deactivation function processing unit) 12m.

The linear processing unit 12c calculates the linear matrix L3(m′×d) using the change matrix Xc(m′×d) and the weight matrix W3(d×d) stored in advance in the parameter 23 of the storage device 20, and outputs the linear matrix L3(m′×d) to the SFDLA processing unit 12s.

The deactivation function processing unit 121 is provided at a subsequent stage of the linear processing unit 12a. The deactivation function processing unit 121 performs deactivation function processing on the linear matrix L1(m′×d) calculated by the linear processing unit 12a to calculate the matrix ReLU1(m′×d), and outputs the matrix ReLU1(m′×d) to the attention unit 12t.

The deactivation function processing unit 12m is provided at a subsequent stage of the linear processing unit 12b. The deactivation function processing unit 12m performs deactivation function processing on the linear matrix L2(m′×d) calculated by the linear processing unit 12b to calculate the matrix ReLU2(m′×d), and outputs the matrix ReLU2(m′×d) to the SFDLA processing unit 12s.

In the first frame, the SFDLA processing unit 12s calculates a matrix A that is a matrix product of a portion not updated even once in the second and subsequent frames of the matrix ReLU2(m′×d)(matrix Q1) calculated by the deactivation function processing unit 12m, and a portion not updated even once after the second and subsequent frames of the linear matrix L3(m′×d)(matrix K1) calculated by the linear processing unit 12c.

In addition, in the first frame, the SFDLA processing unit 12s calculates a matrix B1 that is a matrix product of a portion updated at least once in the second and subsequent frames of the matrix ReLU2(m′×d) calculated by the deactivation function processing unit 12m and a portion updated at least once in the second and subsequent frames of the linear matrix L3(m′×d) calculated by the linear processing unit 12c.

The portion not updated indicates x-y coordinates not extracted by the extraction unit 11. An extracted position is determined to be an important area and is subjected to multiplication and updated in the SFDLA processing unit 12s, and the other portion is not updated since a previous multiplication result is reused therefore.

Next, the SFDLA processing unit 12s calculates a matrix sum of the matrix A and the matrix B1, and outputs a matrix C1 (SFDLA(d×d)) of the first frame to the attention unit 12t.

Furthermore, the SFDLA processing unit 12s reflects an updated token on the matrix ReLU2(m′×d)(matrix Qi−1) calculated by the deactivation function processing unit 12m and the linear matrix L3(m′×d)(matrix Ki−1) calculated by the linear processing unit 12c in the second and subsequent frames, and calculates the matrix ReLU2(m′ xd)(matrix Qi) and the linear matrix L3(m′×d)(matrix Ki) calculated by the linear processing unit 12c in the third frame. Here, i is an integer of two or more.

The updated token indicates a token extracted by the extraction unit 11 and determined to be important.

Next, the SFDLA processing unit 12s calculates a matrix Bi that is a matrix product of a portion updated at least once in the second and subsequent frames of the matrix ReLU2(m′×d)(matrix Qi) calculated by the deactivation function processing unit 12m and a portion updated at least once in the second and subsequent frames of the linear matrix L3(m′×d)(matrix Ki) calculated by the linear processing unit 12c.

Next, the SFDLA processing unit 12s calculates a matrix sum of the matrix A and the matrix Bi, and outputs a matrix Ci (SFDLA(d×d)) in the second and subsequent frames to the attention unit 12t.

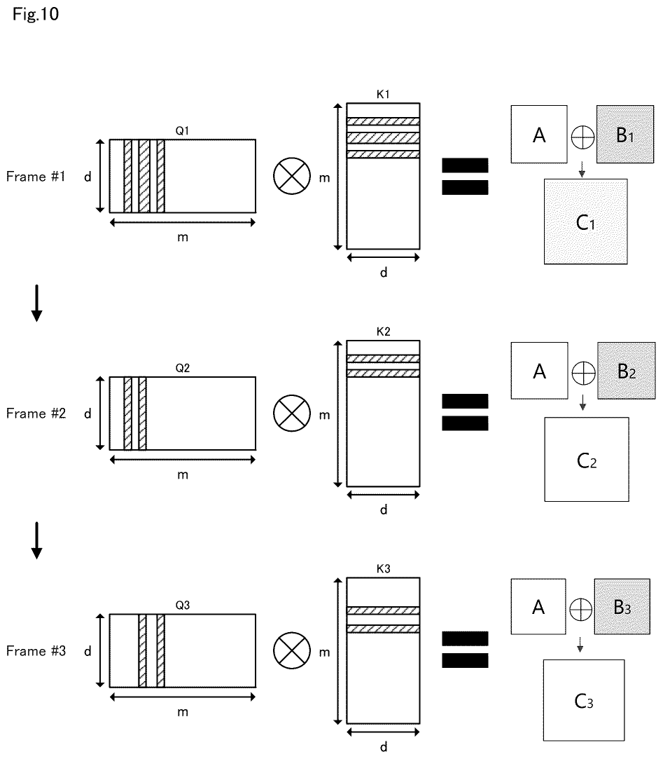

FIG. 10 is a diagram for describing an example of an SFDLA processing unit. In the SFDLA processing unit 12s, a large-capacity memory is required if a calculation result in a previous frame (image) is simply stored. That is, the memory for d·d·m is required. Therefore, a calculation method is changed between Frame #1 and Frame #2 to reduce the required memory. The patch size is a value larger than one.

Calculation in Frame #1 will be described.

First, in Frame #1 in FIG. 10, a matrix product of tokens (blank areas in FIG. 10: areas other than hatched ranges) that are not updated even once in Frame #2 and subsequent frames is calculated by the matrix Q1 (ReLU2(m′×d) of Frame #1) and the matrix K1 (linear matrix L3(m′×d) of Frame #1), and is set as the matrix A (K change matrix).

Next, a matrix product of tokens (hatched ranges) that are updated at least once in Frame #2 and subsequent frames is calculated using the matrix Q1 and the matrix K1, thereby calculating the matrix B1.

Next, a matrix sum of the matrix A and the matrix B1 is calculated, thereby calculating the matrix C1 (mathematically equivalent to a general matrix product).

Calculation in Frame #i after Frame #2 will be described.

First, in Frame #2 and subsequent frames in FIG. 10, the matrix Qi and the matrix Ki are calculated by reflecting the updated token on the matrix Qi−1 (ReLU2(m′×d) of Frame #n−1) and the matrix Ki—1 (the linear matrix L3(m′×d) of Frame #i-1).

Next, in the matrix Qi and the matrix Ki, a matrix product of tokens (shaded ranges) that are updated at least once in Frame #2 and subsequent frames is calculated, thereby calculating the matrix Bi.

Next, a matrix sum of the matrix A and the matrix Bi is calculated, thereby calculating the matrix Ci (mathematically equivalent to a general matrix product).

As described above, the maximum memory use amount can be reduced to 2·d·m by using the SFDLA processing.

The attention unit 12t calculates a matrix product of the matrix ReLU1(m′×d) calculated by the deactivation function processing unit 121 and the matrix SFDLA(d×d) generated by the SFDLA processing unit 12s, and outputs a matrix A3(m′×d)(seventh matrix) to the substitution unit 12u.

The substitution unit 12u substitutes a portion related to the change portion of the second matrix Yt−1 (n×m×d) indicating the second output features with the matrix A3(m′×d)(seventh matrix) calculated by the attention unit 12t, and outputs the matrix Yt(n×m×d) indicating new second output features.

As described above, when the sparse MSA processing of (4) is adopted, the extraction unit 11 extracts a change portion of tokens, the linear processing units 12a, 12b, and 12c perform linear processing using only compressed change matrices (two-dimensional matrices), related to the change portion, and the SFDLA processing unit 12s and the substitution unit 12u substitute the change portion, so that the computational complexity can be reduced as compared with the conventional MSA processing using linear attention. As a result, the image processing can be speeded up.

### [Device Operation]

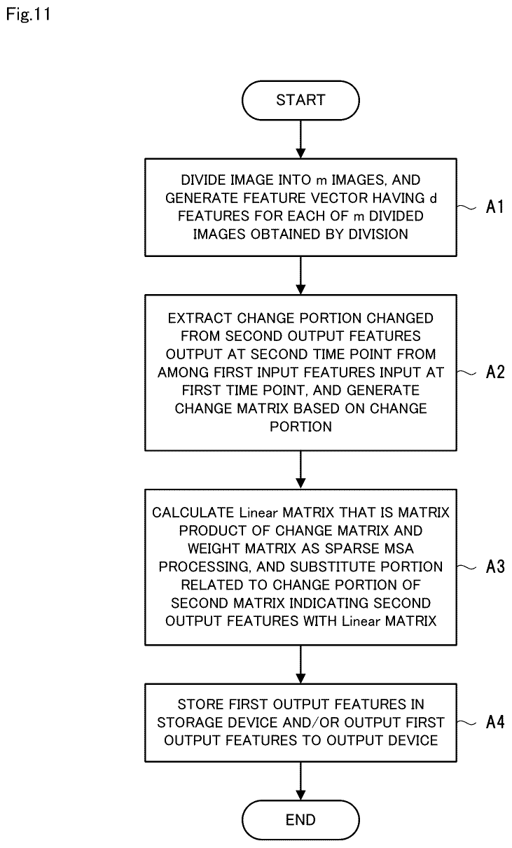

Next, the operation of the image processing device according to the example embodiment will be described with reference to FIG. 11. FIG. 11 is a view for describing the operation of the image processing device. In the following description, the drawings are appropriately referred to. In the example embodiment, an image processing method is performed by operating the image processing device. Therefore, the description of the image processing method in the example embodiment is substituted with the following description of the operation of the image processing device.

As illustrated in FIG. 11, first, the generation unit 13 divides an image into m images, and generates a feature vector having d features for each of the m divided images obtained by the division (step A1).

Specifically, in step A1, the generation unit 13 first acquires images captured in time series by the imaging device (not illustrated). Next, in step A1, the generation unit 13 divides each of the acquired images into preset m images. Next, in step A1, the generation unit 13 generates a feature vector having preset d features for each of the m divided images (patches) obtained by the division. That is, the generation unit 13 generates a first matrix X(n×m×d) indicating input features.

Next, the extraction unit 11 extracts a change portion, changed from second output features output at a second time point, from among first input features input at a first time point, and generates a change matrix based on the change portion (step A2).

Specifically, in step A2, the extraction unit 11 extracts the change portion, changed from the second output features (Yt−1 (n×m×d)) output at the second time point t−1 earlier than the first time point t, from among the first input features (Xt(n×m×d)) input at the first time point t.

Next, in step A2, the extraction unit 11 generates the change matrix Xc(m′×d) based on the change portion of the first matrix Xt(n×m×d) indicating the first input features.

The sparse MSA processing unit 12 calculates the linear matrix L(m′×d), which is the matrix product of the change matrix Xc(m′×d) and the weight matrix W(d×d), and substitutes a portion related to the change portion of the second matrix Yt−1 (n×m×d) indicating the second output features with the linear matrix L(m′×d)(step A3). Refer to (1) to (4) described above for details of the sparse MSA processing unit 12.

The output unit 14 stores the first output features (Yt(n×m×d)) generated by the sparse MSA processing unit 12 in the output image 22 of the storage device 20, and/or outputs the output image 22 to the output device (not illustrated)(step A4).

### Effect of Example Embodiment

As described above, according to the example embodiment, since the tokens (patches) to be calculated can be reduced by adopting sparse MSA processing in (1) to (4) in ViT in the example embodiment, the image processing can be speeded up.

### [Program]

A program in the example embodiment may be a program that causes a computer to execute steps A1 to A4 illustrated in FIG. 11. By installing and executing this program in the computer, the image processing device and the image processing method according to the example embodiment can be achieved. In this case, a processor of the computer functions as the generation unit 13, the extraction unit 11, the sparse MSA processing unit 12, and the output unit 14, and performs processing.

Further, the program in the example embodiment may be executed by a computer system constructed by a plurality of computers. In this case, for example, each of the computers may function as any of the generation unit 13, the extraction unit 11, the sparse MSA processing unit 12, and the output unit 14.

### [Physical Configuration]

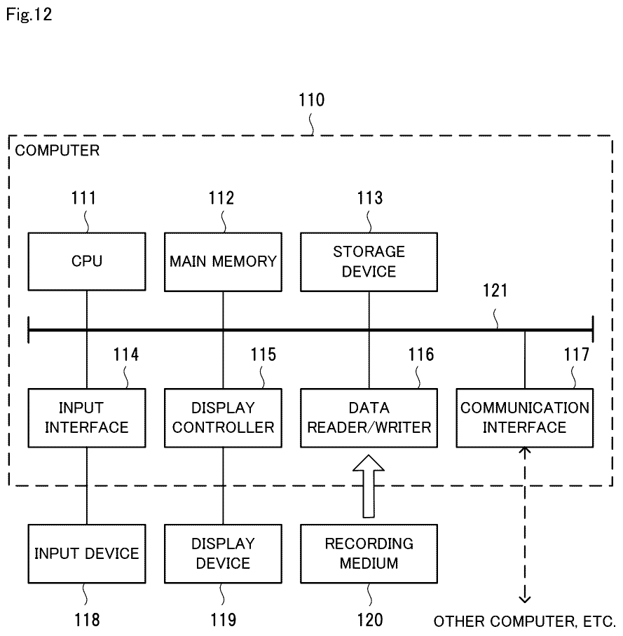

Here, the computer that achieves the image processing device by executing the program in the example embodiment will be described with reference to FIG. 12. FIG. 12 is a diagram for describing an example of a computer that achieves an image processing device according to an example embodiment.

As illustrated in FIG. 12, a computer 110 includes a central processing unit (CPU) 111, a main memory 112, a storage device 113, an input interface 114, a display controller 115, a data reader/writer 116, and a communication interface 117. These units are data-communicably connected to each other via a bus 121. The computer 110 may include a GPU or an FPGA in addition to the CPU 111 or instead of the CPU 111.

The CPU 111 develops the program according to the example embodiment, which is stored in the storage device 113 and configured by a code group, in the main memory 112, and executes each code in a predetermined order to perform various operations. The main memory 112 is typically a volatile storage device such as a dynamic random access memory (DRAM).

The program according to the example embodiment is provided in a state of being stored in a computer-readable recording medium 120. Then, the program in the example embodiment may be distributed on the Internet connected via the communication interface 117.

Specific examples of the storage device 113 include a semiconductor storage device such as a flash memory in addition to a hard disk drive. The input interface 114 mediates data transmission between the CPU 111 and the input device 118 such as a keyboard and a mouse. The display controller 115 is connected to a display device 119 and controls display on the display device 119.

The data reader/writer 116 mediates data transmission between the CPU 111 and the recording medium 120, and reads a program from the recording medium 120 and writes a processing result in the computer 110 to the recording medium 120. The communication interface 117 mediates data transmission between the CPU 111 and another computer.

Specific examples of the recording medium 120 include general-purpose semiconductor storage devices such as Compact Flash (CF)(registered trademark) and a secure digital (SD), a magnetic recording medium such as a flexible disk, and an optical recording medium such as a compact disk read only memory (CD-ROM).

The image processing device 10 in the example embodiment can also be achieved using hardware corresponding to each unit, for example, an electronic circuit, instead of a computer in which a program is installed. Furthermore, a part of the image processing device 10 may be achieved by a program, and the remaining part may be achieved by hardware. In the example embodiment, the computer is not limited to the computer illustrated in FIG. 12.

While the invention has been particularly shown and described with reference to exemplary embodiments thereof, the invention is not limited to these embodiments. It will be understood by those of ordinary skill in the art that various changes in form and details may be made therein without departing from the spirit and scope of the present invention as defined by the claims.

### INDUSTRIAL APPLICABILITY

According to the above description, image processing can be speeded up by reducing tokens to be calculated in ViT. Further, ViT is useful in a field requiring ViT.

While the present disclosure has been particularly shown and described with reference to example embodiments thereof, the present disclosure is not limited to these example embodiments. It will be understood by those of ordinary skill in the art that various changes in form and details may be made therein without departing from the spirit and scope of the present disclosure as defined by the claims. And each embodiment can be appropriately combined with other embodiments.

1. An image processing device comprising:
an extraction unit for extracting a change portion, changed from second output features output at a second time point earlier than a first time point, from among first input features input at the first time point, and generating a change matrix based on the change portion of a first matrix indicating the first input features; and
a sparse multi-head self-attention (MSA) processing unit including a linear processing unit configured to calculate a linear matrix that is a matrix product of the change matrix and a weight matrix, and a substitution unit configured to substitute a portion related to the change portion of a second matrix indicating the second output features with the linear matrix.

2. The image processing device according to claim 1, wherein
the sparse MSA processing unit includes:
a first substitution unit provided at a subsequent stage of a first linear processing unit, a second substitution unit provided at a subsequent stage of a second linear processing unit, and a third substitution unit provided at a subsequent stage of a third linear processing unit;
a first attention unit configured to calculate a matrix product of a matrix calculated by the first substitution unit and a matrix calculated by the second substitution unit, and output a third matrix;
a softmax processing unit configured to normalize the third matrix, and output a normalized matrix; and
a second attention unit configured to calculate a matrix product of a matrix calculated by the third substitution unit and the normalized matrix, and output a matrix indicating new second output features.

3. The image processing device according to claim 2, wherein
the sparse MSA processing unit includes a sparse frame difference attention (SFDA) processing unit provided at a subsequent stage of the first linear processing unit and the second linear processing unit instead of the first substitution unit, the second substitution unit, and the first attention unit, and
the SFDA processing unit is configured to:
calculate a K change matrix that is a matrix product of a linear matrix calculated by the first linear processing unit and the first matrix, and a Q change matrix that is a matrix product of a linear matrix calculated by the second linear processing unit and the first matrix; and
substitute the portion related to the change portion of the second matrix with the K change matrix and the Q change matrix to generate the third matrix.

4. The image processing device according to claim 1, wherein
the sparse MSA processing unit includes:
a first deactivation function processing unit provided at a subsequent stage of a first linear processing unit and configured to perform deactivation function processing on a first linear matrix calculated by the first linear processing unit;
a second deactivation function processing unit provided at a subsequent stage of a second linear processing unit and configured to perform deactivation function processing on a second linear matrix calculated by the second linear processing unit;
a fourth substitution unit provided at a subsequent stage of the second deactivation function processing unit;
a fifth substitution unit provided at a subsequent stage of a third linear processing unit;
a third attention unit configured to calculate a matrix product of a matrix calculated by the fourth substitution unit and a matrix calculated by the fifth substitution unit, and output a fourth matrix;
a fourth attention unit configured to calculate a matrix product of the fourth matrix calculated by the third attention unit and a matrix calculated by the first deactivation function processing unit, and output a fifth matrix; and
a sixth substitution unit provided at a subsequent stage of the fourth attention unit and configured to substitute the portion related to the change portion of the second matrix with the fifth matrix, and output a matrix indicating new second output features.

5. The image processing device according to claim 4, wherein
the sparse MSA processing unit includes a sparse frame difference linear attention (SFDLA) processing unit provided at a subsequent stage of the second deactivation function processing unit and the third linear processing unit instead of the fourth substitution unit, the fifth substitution unit, and the third attention unit, and
the SFDLA processing unit is configured to:
calculate, in a first frame, a matrix A that is a matrix product of a portion of a matrix Q1 calculated by the second deactivation function processing unit, the portion being not updated even once in second and subsequent frames, and a portion of a linear matrix calculated by the third linear processing unit, the portion being not updated even once in the second and subsequent frames;
calculate, in the first frame, a matrix B1 that is a matrix product of a portion of the matrix Q1, the portion being updated at least once in the second and subsequent frames, and a portion of the linear matrix calculated by the third linear processing unit, the portion being updated at least once in the second and subsequent frames;
calculate the fifth matrix, which is a matrix sum of the matrix A and the matrix B1, in the first frame;
reflect an updated token on a matrix Qi−1 calculated by the second deactivation function processing unit and the linear matrix calculated by the third linear processing unit in the second and subsequent frames after the first frame, and calculate a matrix Qi and a matrix Ki in a third frame after the second frame;
calculate a matrix Bi that is a matrix product of a portion of the matrix Qi, the portion being updated at least once in the second and subsequent frames, and a portion of the matrix Ki, the portion being updated at least once in the second and subsequent frames; and
calculate the fifth matrix, which is a matrix sum of the matrix A and the matrix Bi, in the second and subsequent frames.

6. An image processing method performed by an image processing device, the image processing method comprising:
extracting a change portion, changed from second output features output at a second time point earlier than a first time point, from among first input features input at the first time point, and generating a change matrix based on the change portion of a first matrix indicating the first input features; and
executing sparse multi-head self-attention (MSA) processing including calculating a linear matrix that is a matrix product of the change matrix and a weight matrix, and substituting a portion related to the change portion of a second matrix indicating the second output features with the linear matrix.

7. A computer-readable recording medium storing a program for causing a computer to:
extract a change portion, changed from second output features output at a second time point earlier than a first time point, from among first input features input at the first time point and generate a change matrix based on the change portion of a first matrix indicating the first input features; and
execute sparse multi-head self-attention (MSA) processing including calculating a linear matrix that is a matrix product of the change matrix and a weight matrix, and substituting a portion related to the change portion of a second matrix indicating the second output features with the linear matrix.
